(19) United States
(12) Patent Application Publication
(10) Pub. No.: US 2009/0192902 A1
(43) Pub. Date: Jul. 30, 2009

(54) VERTICALLY MOUNTED PRODUCT LOAD SENSOR FOR A RETAIL CHECKOUT STATION

(75) Inventors: Aaron R. Cox, Tucson, AZ (US); Thomas J. Sluchak, Apex, NC (US); Robert P. Tennant, Raleigh, NC (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/020,069

(22) Filed: Jan. 25, 2008

(51) Int. Cl. G06Q 30/00

(52) U.S. Cl. 705/16

(57) ABSTRACT

A retail checkout station includes a housing having at least a front wall that defines a first substantially vertical surface, a first side wall that defines a second substantially vertical surface, and a second side wall that defines a third substantially vertical surface. A product scanning portion is provided at the housing. The product scanning portion includes a scanning device for scanning products purchased by a consumer. A user interface portion having a display is also provided at the housing. The retail checkout station further includes a product load sensor mounted to one of the first, second and third substantially vertical surfaces of the housing.

### BACKGROUND OF THE INVENTION

### Field of the Invention

This invention relates to the art of retail checkout stations and, more particularly, to a product load sensor mounted to a vertical surface of a retail checkout station.

### DESCRIPTION OF BACKGROUND

Retail checkout stations such as, those employed in self-service applications generally rely on a bagging fixture located on a horizontal surface of a weighing platform or scale. After an item is scanned for purchase, the item is moved to a bagging area. The item is placed in a bag that is supported in a bag fixture mounted to the scale. The scale detects a weight of the item placed in the bag. The weight of the item is compared against, and must match, an item weight stored in a master registry before additional items can be scanned. Load cells used in combination with a scale having a horizontal surface are quite large and require a substantial space allocation in the retail checkout station. The need for a comparatively large space for the load cells increases an overall footprint of the checkout station. Most retail businesses do not have an abundance of floor space that can be dedicated to checkout stations and, as such, can only employ a few checkout terminals. Limiting an overall number of checkout stations reduces customer throughput. By reducing customer throughout, wait times at the checkout stations rise and customer satisfaction falls. Decreasing a footprint of the checkout station will enable businesses to employ a greater number of checkout terminals. Increasing available checkout stations will increase customer throughput, decrease wait times and contribute to customer satisfaction.

### SUMMARY OF THE INVENTION

The shortcomings of the prior art are overcome, and additional advantages are provided, through the provision of a retail checkout station constructed in accordance with an exemplary embodiment of the present invention. The retail checkout station includes a housing having at least a front wall that defines a first substantially vertical surface, a first side wall that defines a second substantially vertical surface, and a second side wall that defines a third substantially vertical surface. A product scanning portion is provided at the housing. The product scanning portion includes a scanning device for scanning products purchased by a consumer. A user interface portion having a display is also provided at the housing. The retail checkout station further includes a product load sensor mounted to one of the first, second and third substantially vertical surfaces of the housing.

Additional features and advantages are realized through the techniques of exemplary embodiments of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a front elevational view of a retail checkout station including a vertically mounted product load sensor constructed in accordance with an exemplary embodiment of the present invention;

FIG. 2 is a right side elevational view of the retail checkout station of FIG. 1; and

FIG. 3 is a right side elevational view of a retail checkout station including a vertically mounted product load sensor constructed in accordance with another exemplary embodiment of the present invention.

The detailed description explains the exemplary embodiments of the invention, together with advantages and features, by way of example with reference to the drawings.

### DETAILED DESCRIPTION OF THE INVENTION

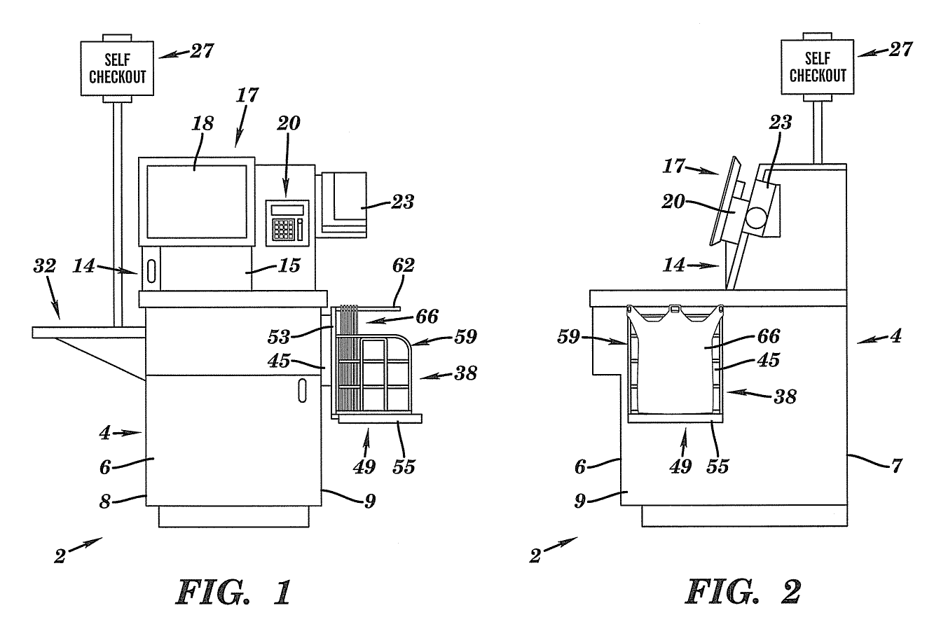

With initial reference to FIGS. 1 and 2, a retail checkout station constructed in accordance with an exemplary embodiment of the present invention is generally indicated at 2. Checkout station 2 includes a housing 4 having a front wall 6 that defines a first substantially vertical surface, a rear wall 7 that defines a second substantially vertical surface, a first side wall 8 that defines a third substantially vertical surface, and a second side wall 9 that defines a fourth substantially vertical surface. Checkout station 2 includes a scanning portion 14 having a scanning device 15 and a user interface portion 17. User interface portion 17 includes a display 18 having a plurality of graphical user interface or GUI buttons (not shown) and a keypad or card reader 20. Checkout station 2 also includes a printer 23 for printing receipts and/or coupons and a status light 27. Status light 27 provides an indication that checkout station 2 is open and/or a customer requires assistance from store personnel. Finally, checkout station 2 is shown to include a pre-scanning portion or counter 32 that serves as a support for items prior to scanning, and a bagging area or zone 38.

In accordance with the exemplary embodiment shown, bagging zone 38 includes a product load sensor 45 mounted to second side wall 9 of housing 4. Product load sensor 45 serves as an interface to a bagging station 49. Bagging station 49 includes a first or substantially vertical wall 53 mounted to product load sensor 45 and a second or substantially horizontal wall 55. Bagging station 49 also includes a bag rack 59 having a plurality of support arms 62 that retain a plurality of bags indicated generally at 66. With this arrangement, items scanned at scanning portion 14 are placed in one or more of bags 66 on bagging station 49. Product load sensor 45 determines a weight of each scanned item placed in bagging station 49. The weight of each item is compared against product weight stored in a master list for security and/or verification purposes to ensure that each item at bagging station 49 is properly scanned.

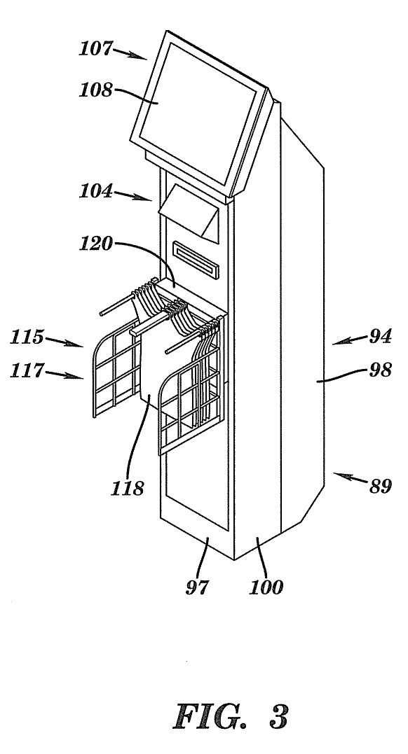

Reference will now be made to FIG. 3 in describing a checkout station or kiosk 89 constructed in accordance with another exemplary embodiment of the present invention. As shown, kiosk 89 includes a housing 94 having a front wall 97 that defines a first substantially vertical surface, a rear wall 98 that defines a second substantially vertical surface, a first side wall (not shown) that defines a third substantially vertical surface, and a second side wall 100 that defines a fourth substantially vertical surface. Kiosk 89 includes a scanning portion 104 having a scanning device (not separately labeled) and a user interface 107 having a display 108 and a card reader (not shown). Kiosk 89 further includes a bagging station 115 that is configured to receive products scanned at scanning portion 104.

In accordance with the embodiment shown in FIG. 3, bagging station 115 includes a bag rack 117 that holds a plurality of bags 118. Bag rack 117 is configured to support large bags and thus is not provided with a bottom or support wall. That is, bags 118 hang freely from bag rack 117 and are not supported on a lower surface thereof. Towards that end, bagging station 115 is secured to a product load sensor 120 that is mounted to front wall 97 of housing 94. Product load sensor 120 determines a weight of each product placed in bagging station 115. In a manner similar to that described above, the weight of each product is compared against product weights stored in a master list for security and verification purposes.

At this point it should be appreciated that exemplary embodiments of the present invention provide a system for determining weight of products at a retail checkout station without increasing an overall footprint of the checkout station. That is, by mounting the product load sensor on a vertical surface of the retail checkout station, space that would otherwise be required for load cells and systems attendant thereto in a lower portion of the housing is no longer necessary and the overall footprint of the checkout station is reduced. At the same time, the present invention enables the use of larger bags and removes the need for horizontal bag supporting surfaces.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A retail checkout station comprising:
a housing having at least a front wall that defines a first substantially vertical surface, a first side wall that defines a second substantially vertical surface, and a second side wall that defines a third substantially vertical surface;
a product scanning portion provided at the housing, the product scanning portion including a scanning device for scanning products purchased by a consumer;
a user interface portion provided at the housing, the user interface portion including a display; and
a product load sensor mounted to one of the first, second and third substantially vertical surfaces of the housing.

2. The retail checkout station according to claim 1, further comprising: a bagging station mounted to the product load sensor on the one of the first, second and third substantially vertical surfaces of the housing.

3. The retail checkout station according to claim 2, wherein the bagging station includes a bag rack.
